(19) United States
(12) Patent Application Publication
(10) Pub. No.: US 2015/0327113 A1
(43) Pub. Date: Nov. 12, 2015

(54) COMMUNICATION DEVICE AND TRAFFIC CONTROL METHOD

(71) Applicant: Jun NISHIOKA, Tokyo (JP)

(72) Inventor: Jun NISHIOKA, Tokyo (JP)

(73) Assignee: NEC Corporation, Tokyo (JP)

(21) Appl. No.: 14/377,473

(22) PCT Filed: Feb. 13, 2013
(86) PCT No.: PCT/JP2013/000758

§ 371 Date: Aug. 7, 2014

(30) Foreign Application Priority Data
Feb. 22, 2012 (JP) 2012-035844

(51) Int. Cl. H04W 28/02; H04W 72/10; H04W 28/10

(52) U.S. Cl. CPC H04W 28/0263; H04W 28/10; H04W 72/10

(57) ABSTRACT

[Problems] A device and a method which can secure the communication quality of a high priority traffic and efficiently accommodate the traffic in a link aggregation in which a plurality of wireless links are bundled are provided.

[Solution to Problems] A plurality of wireless links between nodes are bundled and used, and the wireless link used by the traffic is determined from a stability of a band for each modulation method used for each wireless link and a traffic pattern for each priority of a path.

### TECHNICAL FIELD

The present invention relates to a communication device and a traffic control method.

### BACKGROUND ART

In recent years, with the advancement of informatization, demand for data communication traffic by data communication and the like is increasing. Accordingly, a wider bandwidth network and reduction in network operation cost are required. The network configured with a wireless link such as a Fixed broadband Wireless Access (FWA) that uses a wireless system using a frequency of a millimeter-wave band or the like by which a wide-band transmission can be achieved or the like is used for a portable telephone network or the like. The communication quality of the wireless link varies in accordance with a SNR (Signal to Noise Ratio) or the like of the received signal.

As a technology for realizing a wireless link with wider bandwidth, the attention is focused on, for example, an adaptive modulation technology. The adaptive modulation technology adaptively selects, for example, a symbol rate or a modulation multi-value number according to a transmission path condition (a radio condition of the wireless link) and uses different modulation methods so as to get the best transmission efficiency. By using the adaptive modulation technology, the most suitable wireless communication can be achieved according to a radio environment and the improvement of the frequency utilization efficiency can be expected.

Further, in order to realize a line having a wide transmission band between transmission devices, a link aggregation technology which virtually bundles a plurality of physical lines into one line and uses a band that corresponds to the band obtained by totalizing the bands of the physical lines is used.

In the link aggregation which bundles the plurality of links, a method by which the band can be most efficiently used is a per-packet traffic distribution method which the link used for transmission of a packet is determined for each packet.

However, when the traffic distribution is performed for each packet, a packet order change occurs. For this reason, this method is not suitable for a high priority traffic transmission for which high communication quality is required.

On the other hand, in the link aggregation in which a plurality of wireless links whose bands vary are bundled, when the wireless link used for transmission is fixedly determined for each flow, there is a case in which a traffic is biased. Further, when the transmission rate of a certain wireless link is decreased by an adaptation modulation function, the communication quality of the high priority traffic using this link degrades.

As the traffic control for the link aggregation, for example, in Patent Literature 1, a traffic distribution control device which enables uniform band distribution to a plurality of physical ports constituting a logic port of the link aggregation is disclosed. In Patent Literature 2, a method and a device by which even when a failure occurs in each of the physical lines that are logically integrated as the link aggregation, the band control corresponding to the number of the normal physical lines is performed to a user traffic by referring to the user's band control information for each normal physical line are disclosed. Further, in Patent Literature 3, a packet distribution system in which a bias of a flow rate band distributed to the physical port is found based on information about a maximum flow rate band and an average flow rate band in which an actual traffic flow rate is reflected, an amount of the flow rate band is determined, and the packet is distributed so that the flow rate band of the traffic having a high flow rate band is reduced by the average flow rate band is disclosed.

It is assumed that a wired link in which a link band does not vary is used, in the disclosure of Patent Literature 1 to Patent Literature 3, which cannot be applied to traffic distribution of wireless link considering the case of bandwidth fluctuation caused by adaptive modulation.

In Patent Literature 4, a wireless device which multiplexes and demultiplexes a radio frame transmitted in a radio section composed of a plurality of wireless links in which a multi-link communication is provided in a data link layer for each radio link layer is disclosed. A wireless entrance unit converts a MRL (Multi Radio Line) frame distributed by an aggregation switch into the radio frame and transmits it for each wireless link of the radio section. Further, the wireless entrance unit converts the radio frame received for each wireless link of the radio section into the MRL frame and outputs it to the aggregation switch. Further, the aggregation switch aggregates the MRL frames and reassembles them into a network frame. In the wireless device disclosed in the Patent Literature 4, a division process and a restoration process are required for all the frames and an overhead problem in which a used band increases by header information added at the time of dividing the frame occurs.

Further, in Patent Literature 5, a communication device which distributes the packet according to QoS (Quality of Service) to each wireless system in a communication environment in which a plurality of different wireless systems such as a cognitive wireless system and the like are used is disclosed. In the communication device, the wireless link used for transmission is determined by taking into consideration the priority of the traffic and the quality of the wireless link. Since the process is performed on a per-packet basis, a packet order change cannot be avoided, which makes this communication device unsuitable for a high priority traffic.

In the invention disclosed in Patent Literature 6, a receiver performs a selective measurement with respect to a downlink transmission, combines a past measurement value (or past channel quality estimation) and a current measurement value (or current channel quality estimation), predicts a channel quality at a certain time in the future, and derives a predicted channel quality indicator (CQI). The predicted CQI is transmitted to a transmitter and used for an update of a transmission parameter. Further, the CQI represents one of a recommended transport block size, a modulation format, the number of the codes, a power offset, and a plurality of different types of link adaptation parameters.

In Patent Literature 7, a device which predicts the degradation in line quality due to rain from rainfall information, performs band priority control in advance, so that it transmits information that cannot be transmitted by an interruption due to rain in advance, thereby reducing degradation in throughput due to line quality degradation of the wireless line is disclosed.

### CITATION LIST

### Patent Literature

[PTL 1] Japanese Patent Application Laid-Open No. 2006-5437
[PTL 2] Japanese Patent Application Laid-Open No. 2007-67586
[PTL 3] Japanese Patent Application Laid-Open No. 2011-103614
[PTL 4] Japanese Patent Application Laid-Open No. 2010-258606
[PTL 5] Japanese Patent Application Laid-Open No. 2009-141438
[PTL 6] Japanese Unexamined Patent Application Publication (Translation of PCT Application) No. 2006-505221
[PTL 7] Japanese Patent Application Laid-Open No. 2004-363679

### Non Patent Literature

[NPL 1] Jun Nishioka, Satoru Yamano, “A Study on Routing over AMC-enabled FWA Mesh Network”, IEICE technical report, January 2009, vol. 108, no. 392, NS2008-134, pp. 49-54

### SUMMARY OF INVENTION

### Technical Problem

The related technologies will be analyzed below.

In traffic transmission between the communication devices connected by a plurality of wireless links, it is difficult to perform a traffic processing which satisfies both of the following conditions:
the communication quality of the high priority traffic can be guaranteed; and
the link band can be effectively used.

Further, in the technology disclosed in Patent Literature 1 to Patent Literature 3, it is assumed that a wired link in which the link band does not vary is used. Therefore, this technology cannot distribute the traffic of the wireless link considering the case of the band fluctuation caused by adaptation modulation. Further, in the technology disclosed in Patent Literature 4, a division process and a restoration process are required for all the frames and an overhead problem in which a used band increases by adding header information at the time of dividing the frame occurs. The technology disclosed in Patent Literature 5 determines the wireless link used for transmission by taking into consideration the priority of the traffic and the quality of the wireless link. However, since the process is performed on a per-packet basis, a packet order change cannot be avoided, which makes this technology unsuitable for the high priority traffic.

The present invention is made in view of the above problem. The object is to provide a device and a method which can secure the communication quality of the high priority traffic and efficiently accommodate the traffic in the link aggregation in which a plurality of wireless links is bundled.

### Solution to Problem

According to the present invention, a traffic control method in which a plurality of wireless links between nodes for use, and the wireless link used by a traffic is determined from a stability of a band for each modulation method used for each wireless link and a traffic pattern for each priority of a path is provided.

According to the present invention, a communication device comprises a means for bundling a plurality of wireless links between the communication devices for use it, and determining the wireless link used by a traffic from a stability of a band for each modulation method used for each wireless link and a traffic pattern for each priority of a path is provided.

### Advantageous Effects of Invention

An exemplary advantage according to the invention, in the link aggregation in which a plurality of wireless links are bundled, the communication quality of the high priority traffic can be secured and the traffic can be efficiently accommodated.

### BRIEF DESCRIPTION OF DRAWINGS

FIG. 1 is a figure showing one example of a configuration of a network system according to one exemplary embodiment of the present invention.

FIG. 2 is a flowchart showing an operation procedure of one exemplary embodiment of the present invention.

FIG. 3 is a figure for explaining a first exemplary embodiment of the present invention.

FIG. 4 is a figure for explaining a second exemplary embodiment of the present invention.

FIG. 5 is a figure showing a configuration of a communication device according to one exemplary embodiment of the present invention.

### DESCRIPTION OF EMBODIMENTS

First, a principle of the present invention will be described. Next, an exemplary embodiment will be described as an example. Although not restricted in particular, in the following exemplary embodiment and the like, an explanation will be made about a route control in a mobile backhaul network, in particular, will be made in line with an application example for a network composed of the wireless link having an adaptation modulation function.

When the traffic is distributed to a plurality of wireless links, an influence on the communication quality of the traffic caused by a change in transmission rate of the wireless link by the adaptation modulation has to be considered. The change in transmission rate by the adaptation modulation occurs by, for example, a change in band due to weather or the like. A certain amount of band remains even when the transmission rate is reduced by the adaptation modulation except for a case in which a wireless link failure occurs.

It is desirable to predict (estimate) the modulation method used by the wireless link and allocate the band which can be stably provided even when the low modulation method (low transmission rate) is used to the high priority traffic which requires the high communication quality.

On the other hand, for a traffic with a strong burst characteristic like a data traffic, available band is more important than the communication quality. Thus, the band (which, for example, cannot be used temporarily with high probability) that is provided by using the high modulation method (high transmission rate) may be allocated to the low priority traffic which does not require a relatively high communication quality.

Further, in the traffic distribution to a plurality of wireless links, when the packet is distributed to the plurality of wireless links by the round robin method (the method in which the resource is allocated in turns), a packet order change occurs. Therefore, the round robin method is not suitable for the traffic that requires a high communication quality.

It is desirable to determine the wireless link used for transmission on a per-flow basis in which each flow is identified by a pair of a transmission source (a packet transmission source) and a transmission destination (a destination of the packet) or the like.

As described above, when the traffic is fixedly allocated to the wireless link used for transmission on a per-flow basis, by the traffic amount difference between the flows or the like, the bias of the total traffic amount that flows in the wireless link may occur. For this reason, the plurality of wireless links cannot be efficiently used.

As mentioned above, according to the communication quality required for the traffic, the most suitable method is different from each other with respect to the band of the wireless link used for transmission, the traffic distribution method, or the like.

Accordingly, in the present invention, according to the communication quality required for the traffic, the traffic is distributed by taking into consideration the difference of the band of the wireless link used for transmission and the difference of the traffic distribution method.

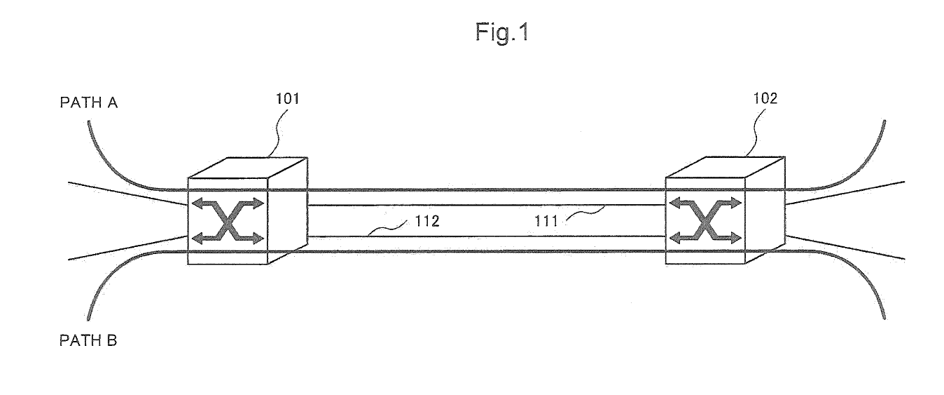

For example, according to an exemplary embodiment shown as an example, referring to FIG. 1, two communication devices (101 and 102) are connected to destination communication devices (102 and 101) by a plurality of wireless links (111 and 112), respectively, and the most suitable band allocation and the traffic distribution are performed based on a state of the wireless link of the communication device itself (101 or 102) and information of the traffic that flows.

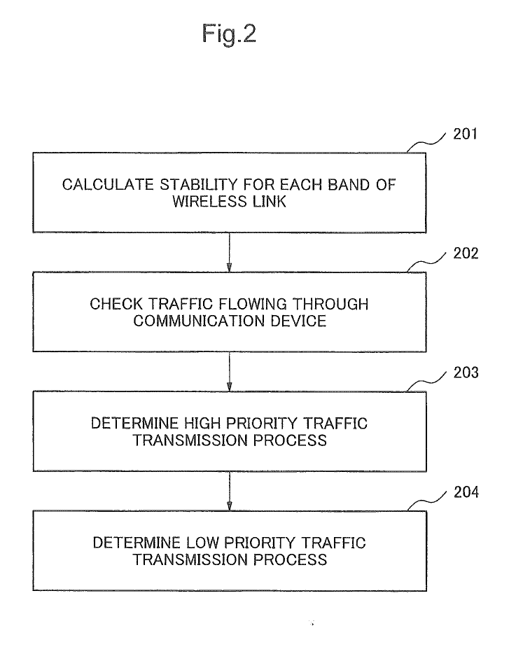

FIG. 2 is a flowchart for explaining a process procedure according to an exemplary embodiment shown as an example. The process procedure according to the exemplary embodiment shown as an example will be described with reference to FIG. 1 and FIG. 2.

The communication devices (101 and 102) check the states of the wireless links through which the communication devices (101 and 102) are connected to the destination communication devices (102 and 101), respectively (Step 201). At the time, the communication devices (101 and 102) acquire, for example, a history of the modulation method used in the past, weather information, or the like and calculate the stability for each band with respect to the band (the increased band) provided by using each modulation method used for the wireless link. The stability of a modulation method c indicates a percentage of the use of the modulation method c or the modulation method having a higher transmission rate than that of the modulation method c. For example, the stability is calculated for each interval (time interval) Tᵢₙₜₑᵣᵥₐₗ and a stability Sₜ[c] of the modulation method c during a t-th interval is given by the following equation. Where, M is a set of the modulation methods used for the wireless link and c is included in M (refer to equation (3) described in Non-Patent Literature 1).

$${S}_{t} [ c ] = \frac{{\sum }_{m = c}^{max ( M )} {T}_{m}}{{T}_{interval}} c$$

A final stability FSₜ[c] can be obtained by reflecting the value obtained in the past by using the moving average or the like of the stability Sₜ[c] for each interval (refer to equation (4) shown in Non-Patent Literature 1).

Further, refer to the above-mentioned Patent Literature 7 and another document with respect to the control of the wireless line based on the weather information or the like.

Although not restricted in particular, as the modulation method selected by the adaptation modulation includes, for example, QPSK (Quadrature Phase Shift Keying), 16QAM (Quadrature Amplitude Modulation), 32QAM, 128QAM, and the like. According to the modulation method used for the wireless link, the transmission rate increases. For example, when QPSK is used as the modulation method, the transmission rate is 40 Mbps (Mega bits per second) and when 16QAM is used as the modulation method, the transmission rate is 80 Mbps. The difference between the transmission rate of 16QAM and transmission rate of QPSK that is a step lower modulation method than 16QAM is 40 Mbps (=80 Mbps−40 Mbps). In the adaptation modulation, when the modulation method is changed from QPSK to 16QAM, the band of the wireless link increases by 40 Mbps. This band of 40 Mbps is a band provided by 16QAM. Because this band can be used when the modulation method whose transmission rate is greater than that of 16QAM is used, the stability of 16QAM is equal to the stability of the band.

After that, when a path through which the traffic flows is set to the communication devices (101 and 102) by an external routing control device (not shown) or the like, the communication devices (101 and 102) check the traffic information (Step 202).

The communication devices (101 and 102) obtain the band which can be used by the high priority traffic based on the stability for each band (Step 203).

For example, the stability of the band that is required for each priority is designated in advance with respect to the entire network including the communication devices (101 and 102). The communication devices (101 and 102) check the band to which the high priority traffic or the low priority traffic can be allocated from among the bands which meet the stability required for each priority. Further, the communication devices (101 and 102) grasp the priority (for example, high priority, low priority, or the like) of the traffic from the priority information described in the header of each frame. Further, for example, the designation of the priority is performed in advance by the operator based on a type of traffic. For example, the priority is designated based on a QCI (QoS Class Identifier) of the 3GPP (3rd Generation Partnership Project). Further, in a case in which by the external routing control device (not shown), the communication devices (101 and 102) are notified of an amount of the high priority traffic that flows on the basis of path flow in advance, the communication devices (101 and 102) may determine the wireless link used when transferring the high priority traffic based on the traffic amount and the band that is allocated to the high priority traffic. On the other hand, in a case in which the traffic amount of the high priority traffic cannot be obtained for each flow, as will be described later, the communication devices (101 and 102) may determine the wireless link used for transmission by taking into consideration a ratio of an unused band in the band with high reliability.

Next, the communication devices (101 and 102) determine the process to the low priority traffic (Step 204).

In case of the low priority traffic, the communication devices (101 and 102) distribute the traffic by taking into consideration the unused band of each wireless link including the band with low reliability. As an example of this method, a per-packet traffic distribution method in which the wireless link used for transmission is changed for each packet according to the ratio of the unused band for each wireless link is used.

Usually, one of the following two alternatives has to be selected:

(I) fixedly using the same wireless link for the traffic on the same path; and

(II) distributing all the traffics on a per-packet basis. Therefore, one of the communication quality and the efficiency cannot be satisfied.

In contrast, by using the present invention, the followings are made possible:

(A) maintaining the communication quality of the high priority traffic for which the high communication quality is required; and

(B) using efficiently the band of a plurality of wireless links.

An exemplary embodiment 1 of the present invention will be described below. The exemplary embodiment 1 is applied to a communication device which is connected to the same communication device (the same connection destination) via a plurality of wireless links. As shown in FIG. 1, the communication device 101 is connected to the communication device 102 via a plurality of wireless links 111 and 112. In the exemplary embodiment 1, the communication devices 101 and 102 determine how to use wireless links 111 and 112 for distributing the traffic flowing between the communication devices 101 and 102. This process will be described.

The communication devices 101 and 102 check wireless link states of themselves that are held in a storage device (not shown) and calculate the stability for each band for each modulation method from the past history and statistical information (for example, trend information such as an average value, a maximum value, a minimum value, or the like) (Step 201 of FIG. 2).

The communication devices 101 and 102 measure the traffic flowing through the communication devices 101 and 102 and classify the traffic into a path and a flow within the recognition capability of the communication devices 101 and 102, respectively (Step 202 of FIG. 2). The communication devices 101 and 102 identify the traffic for each path or flow based on the header information of the frame that is accessible by the communication devices 101 and 102. In Step 202 of FIG. 2, the communication devices 101 and 102 further classify the path or the flow in detail based on the priority.

Next, the communication devices 101 and 102 allocate the traffic to one of the wireless links according to the path/flow and the priority (Steps 203 and 204 of FIG. 2).

With respect to the allocation of the high priority traffic to the wireless link (Step 203 of FIG. 2), the communication devices 101 and 102 determines the wireless link used for transmission so as to transmit the traffic by using the same wireless link and the band with high stability preferably. Here, when the traffic granularity which can be recognized by the communication devices 101 and 102 is a path unit such as an LSP (Label Switched Path) or the like of a MPLS (Multi-Protocol Label Switching), the path is recognized in a label unit and when it is a VLAN (Virtual Local Area Network), the communication devices 101 and 102 recognize the path based on a VLAN ID and set the link in the path unit. When the communication devices 101 and 102 can read an IP (Internet Protocol) header of each packet, the communication devices 101 and 102 recognize it in a flow unit whose granularity is more fine by a set of the IP address of the transmission source and the IP address of the destination or the like and set the link in a flow unit. The communication devices 101 and 102 grasp the priority of the traffic from the priority (MPLS: EXP bit, VLAN: bit PCP (Priority Code Point) showing the order of priority, and IP: TOS (Type Of Service) showing the priority of the IP packet) of each header.

Next, with respect to the allocation of the low priority traffic to the wireless link (Step 204 of FIG. 2), when a granularity level recognized by the communication devices 101 and 102 is a path unit that is rough, the communication devices 101 and 102 change the wireless link used for transmission of the packet on a per-packet basis based on the ratio of the unused band of each wireless link and transmit it.

Here, the unused band which is taken into consideration by the communication devices 101 and 102 is the band that can be used by each wireless link from which the band considered as the band used for the high priority traffic is excluded and in order to maximally use the band of each link, the wireless link used for transmission is changed on a per-packet basis.

Further, when the granularity level which can be recognized by the communication devices 101 and 102 is a flow unit that is more fine, the communication devices 101 and 102 set the link used for communication based on the ratio of the unused band on a per-flow basis and change the wireless link used for transmission according to the change of the traffic amount of each flow.

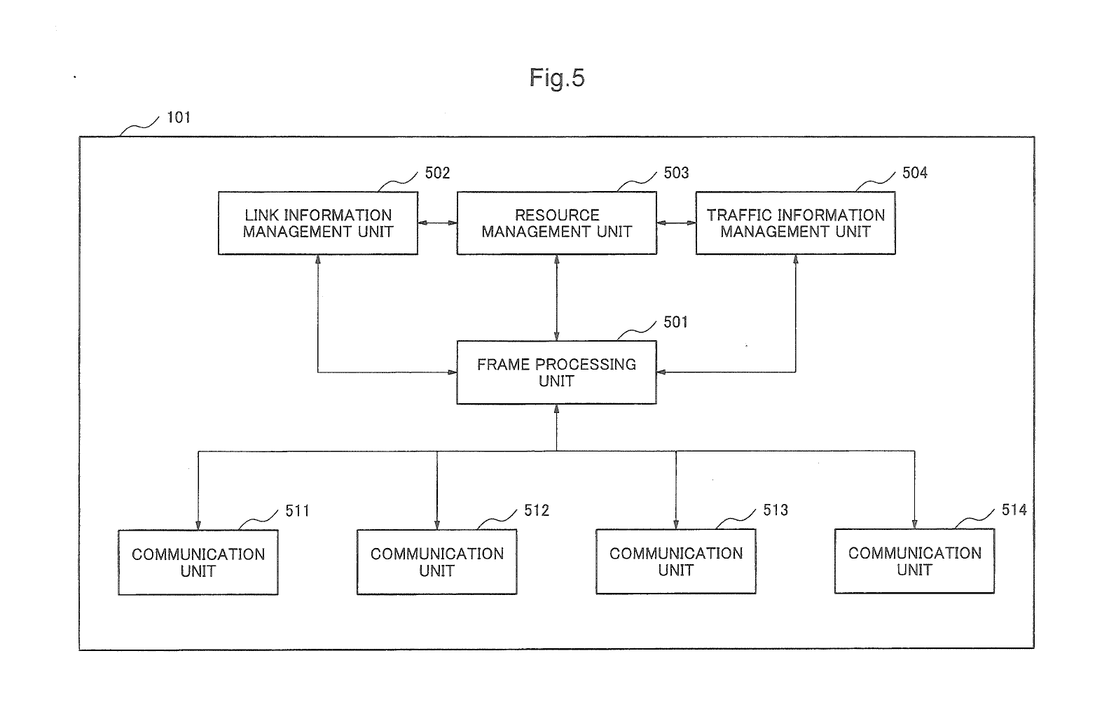

FIG. 5 is a figure showing an example of a configuration of the wireless communication device (the communication devices 101 and 102 shown in FIG. 1) which performs the link aggregation which bundles a plurality of wireless links. Further, because the communication devices 101 and 102 have the same configuration, only the communication device 101 will be described below. The communication device 101 includes communication units 511, 512, 513, and 514 that are connected to a plurality of wireless links and perform wireless communication with a destination communication device, a frame processing unit 501, a link information management unit 502, a resource management unit 503, and a traffic information management unit 504.

The traffic information management unit 504 manages traffic amount information on the basis of path flow or the like in addition to a routing table for each destination. Namely, the traffic information management unit 504 manages for example, a used band, a destination communication device, and a traffic amount for each priority as the traffic information that flows in the wireless link.

The frame processing unit 501 identifies the traffic on the basis of path flow, measures the traffic amount, and stores information including information of a next destination in the traffic information management unit 504 in addition to a frame transmission based on the destination information stored in the traffic information management unit 504.

The communication quality of the wireless link is measured by the communication units 511 to 514 and stored in the link information management unit 502. Further, when the frame processing unit 501 acquires weather information from the outside through the communication units 511 to 514, the frame processing unit 501 records the information in the link information management unit 502.

The link information management unit 502 manages for example, a stability of each modulation method, a BER (Bit Error Rate), a SNR (Signal to Noise Ratio), and a modulation method that is currently used as link quality information. For example, the resource management unit 503 calculates a traffic allocation setting based on the traffic information periodically recorded in the traffic information management unit 504 and the link information of the link information management unit 502 and updates the routing table for each destination of the traffic information management unit 504.

Further, the stability calculation in step 201 of FIG. 2 is performed by the link information management unit 502 shown in FIG. 5, the traffic information check in step 202 of FIG. 2 is performed by the frame processing unit 501 shown in FIG. 5, and the results are recorded in the traffic information management unit 504. The settings of the high priority traffic transmission process in step 203 and the low priority traffic transmission process in step 204 of FIG. 2 are performed by the resource management unit 503 shown in FIG. 5 and the frame processing unit 501 transmits the frame based on the settings. Hereinafter, these processes will be explained in line with a specific example.

### Exemplary Embodiment 1

In an exemplary embodiment 1, an explanation will made about an example of a case in which the traffic granularity which can be recognized by the communication device is a path unit that is relatively rough. Further, of course, the value used in the exemplary embodiment 1 is shown as an example. Therefore, the value should not be interpreted as a limitation of a scope of the present invention.

The communication devices 101 and 102 shown in FIG. 1 are connected to each other by two wireless links 111 and 112. It is assumed that the bands of the wireless links 111 and 112 are as follows (further, in the following description, the reliability may be used instead of the stability).

The wireless link 111: the maximum transmission speed is 155 Mbps and the stability is better than 99.99% when the transmission speed is up to 40 Mbps.

The wireless link 112: the maximum transmission speed is 155 Mbps and the stability is better than 99.99% when the transmission speed is up to 80 Mbps.

It is assumed that the following traffic flows from the communication device 101 to the communication device 102.

A path A (VLAN ID=0): The transmission speed of the high priority traffic is 30 Mbps (maximum) and the transmission speed of the low priority traffic is 70 Mbps (average).

A path B (VLAN ID=1): The transmission speed of the high priority traffic is 70 Mbps (maximum) and the transmission speed of the low priority traffic is 110 Mbps (average).

Here, the communication device 101 (102) transmits the traffic as follows.

First, the wireless link used for the high priority traffic of the paths A and B is determined.

The best match band allocation setting is determined from a size of the band in which the stability is better than 99.99% and the traffic amount of each wireless link. As a result, the high priority traffic of the path A uses the band of the wireless link 111 in which the stability is better than 99.99% and the high priority traffic of the path B uses the band of the wireless link 112 in which the stability is better than 99.99%.

Next, the low priority traffic of each path is distributed to the wireless link on a per-packet basis and transmitted. At this time, the wireless link used for transmission of the low priority traffic is determined according to the ratio of the unused band from which the band through which the high priority traffic will be transmitted is excluded.

The unused band of the wireless link 111 is 125 Mbps (=155−30).

The unused band of the wireless link 112 is 85 Mbps (=155−70).

Accordingly, the ratio of the unused band of the wireless link 111 to the unused band of the wireless link 112 that are used for transmission of the packet is calculated as follows.

The unused band of the wireless link 111: the unused band of the wireless link 112=125:85=25:17.

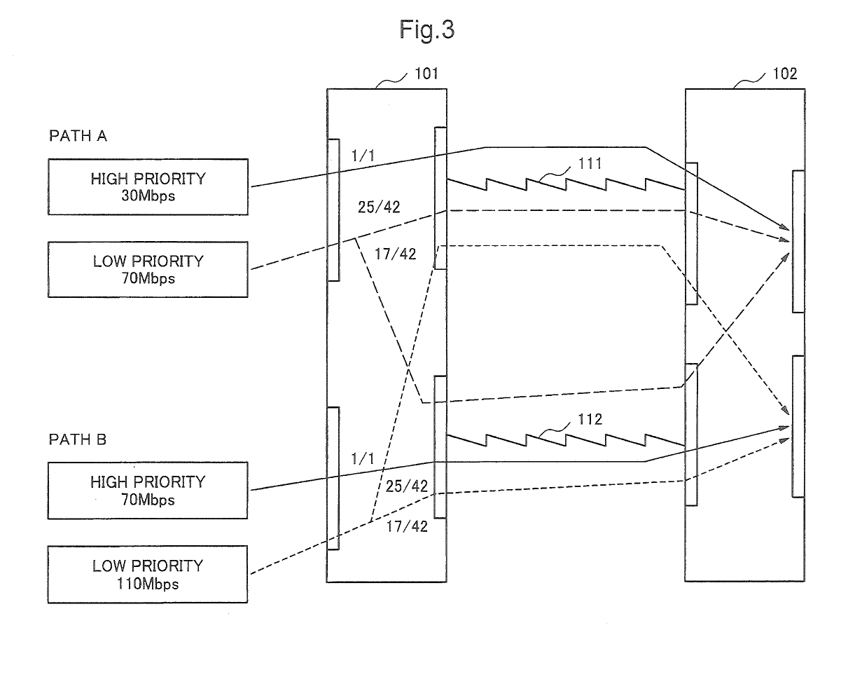

The low priority traffic of the path A and the path B is distributed to the wireless link 111 and the wireless link 112 at a ratio of 25:17. FIG. 3 is a figure schematically showing a result of a traffic control performed in the exemplary embodiment 1. In FIG. 3, it is schematically shown that the low priority traffic of the paths A and B is distributed to the wireless link 111 at a ratio of 25:42 and to the wireless link 112 at a ratio of 17:42.

### Exemplary Embodiment 2

In the exemplary embodiment 2, the high priority traffic is transmitted in the same manner as the above-mentioned exemplary embodiment 1. With respect to the low priority traffic, an average traffic amount of the low priority traffic of each path is compared with the unused band (a remaining portion of the band after allocating to the high priority traffic) in each link and a combination of the average traffic amount and the unused band is found out that gives the minimum difference (absolute value) between them.

As a result, when the low priority traffic of the path A uses the wireless link 112 (difference=|125−110|=15) and the low priority traffic of the path B uses the wireless link 111 (difference=|85−70|=15), the difference is minimum.

The communication devices 101 and 102 perform a setting so that each low priority traffic is transmitted through the wireless link different from the wireless link used for the high priority traffic. The wireless link used by each traffic is shown below.

The path A: The high priority traffic is transmitted through the wireless link 111 and the low priority traffic is transmitted through the wireless link 112.

The path B: The high priority traffic is transmitted through the wireless link 112 and the low priority traffic is transmitted through the wireless link 111.

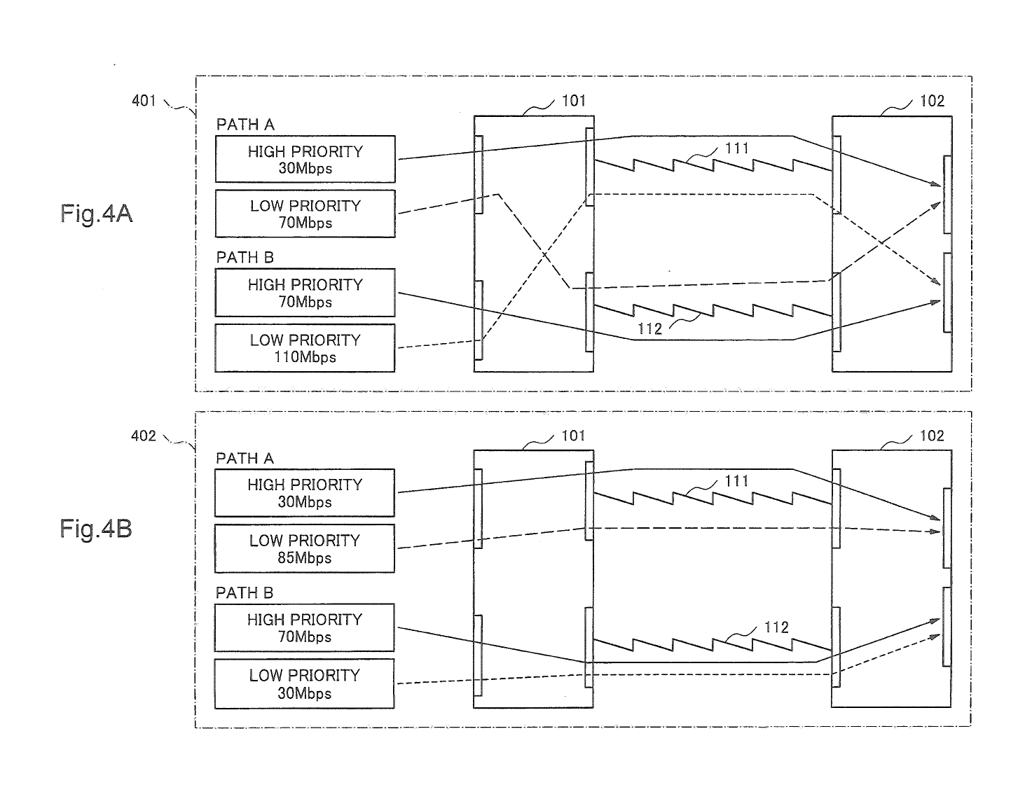

As a result, the link setting of each traffic is shown in a part 401 surrounded by a dashed line of FIG. 4(A).

After this process, the communication devices 101 and 102 periodically measure the average traffic amount of the low priority traffic of each path and at the same time, check the most suitable link for transmission of the low priority traffic. For example, it is assumed that the average traffic amount of the low priority traffic of each path changes as follows.

the path A: from 70 Mbps to 85 Mbps

the path B: from 110 Mbps to 30 Mbps

In this case, when the low priority traffic of the path A uses the wireless link 111 and the low priority traffic of the path B uses the wireless link 112, the difference between the unused band and the average traffic amount is small. Therefore, the communication devices 101 and 102 change the wireless link used for the low priority traffic. That is,

(1) when the wireless links 111 and 112 are used for transmission of the low priority traffics of the paths A and B, respectively, the difference between the unused band and the average traffic amount is calculated as follows; |125−85|=40 when the wireless link 112 is used for the path B and |85−30|=55 when the wireless link 111 is used for path A.

(2) when the wireless links 112 and 111 are used for transmission of the low priority traffics of the paths A and B, respectively, the difference between the unused band and the average traffic amount is calculated as follows; |1125−30|=95 when the wireless link 112 is used for path A and |85−85|=0 when the wireless link 111 is used for path B. Therefore, the combination is changed to the combination of (1) giving smaller maximum absolute value of difference between the unused band and the average traffic amount.

The link setting of each traffic after the change is shown in a part 402 surrounded by a dashed line of FIG. 4(B). Referring to FIG. 4(B), the wireless link 111 is used for the low priority traffic of the path A and the wireless link 112 is used for the low priority traffic of the path B.

Thus, by using the exemplary embodiment 2, when the traffic amount of the low priority traffic varies, the link band can be efficiently used without affecting the high priority traffic.

While two wireless links 111 and 112 are used in the above-mentioned exemplary embodiment, the number of the wireless links bundled by the link aggregation is not limited to two.

According to the above-mentioned exemplary embodiment, by employing the traffic control taking into consideration both the priority of the traffic and the band whose stability in the wireless link is different from others, the communication quality of the high priority traffic can be guaranteed and also the link band can be efficiently used.

The whole or part of the exemplary embodiments disclosed above can be described as, but not limited to, the following supplementary notes.

(Supplementary Note 1)

A traffic control method characterized by comprising the steps of:

bundling a plurality of wireless links between nodes for use, and

determining the wireless link used by a traffic from a stability of a band for each modulation method used for each wireless link and a traffic pattern for each priority of a path.

(Supplementary Note 2)

The traffic control method described in Supplementary note 1 characterized in that a traffic distribution is performed to the traffics on the same path so as to satisfy the communication quality required by each traffic according to the traffic pattern and the priority of the path.

(Supplementary Note 3)

The traffic control method described in Supplementary note 1 or Supplementary note 2 characterized in that the traffic pattern is a pattern indicating a characteristic of the traffic that includes at least one of an average traffic amount, a maximum traffic amount, and a burst characteristic.

(Supplementary Note 4)

The traffic control method described in any one of Supplementary notes 1 to 3 characterized in that the modulation method used for the wireless link is predicted and the stability of the band for the modulation method used for the wireless link is calculated based on the predicted modulation method.

(Supplementary Note 5)

The traffic control method described in any one of Supplementary notes 1 to 4 characterized in that the stability of the band for the modulation method used for the wireless link is calculated based on a history of the modulation method used for the wireless link and a history of information indicating a radio wave environment of the wireless link.

(Supplementary Note 6)

The traffic control method described in any one of Supplementary notes 1 to 5 characterized in that from a size of the band in which the stability of the wireless link is equal to or greater than a predetermined value set in advance and a traffic amount of each path,

the band of the wireless link in which the stability is equal to or greater than the predetermined value set in advance and which has a band equal to or greater than the traffic amount is allocated to at least a first traffic which has a higher priority of each path, and

a plurality of wireless links on a per-packet basis based on a ratio of an unused band from which the band used by the first traffic of each wireless link is excluded are allocated to at least a second traffic which has a lower priority of each path.

(Supplementary Note 7)

The traffic control method described in any one of Supplementary notes 1 to 5 characterized in that from a size of the band in which the stability of the wireless link is equal to or greater than a predetermined value set in advance and a traffic amount of each path,

the band of the wireless link in which the stability is equal to or greater than the predetermined value set in advance and which has a band equal to or greater than the traffic amount is allocated to at least the first traffic which has a higher priority of each path, and

an average traffic amount of the second traffic of each path and the unused band in each wireless link are compared with each other and the wireless link is allocated to at least the second traffic which has a lower priority of each path based on the difference between the unused band and the average traffic amount.

(Supplementary Note 8)

A communication device characterized in that the communication device comprises a means for

bundling a plurality of wireless links between the communication devices for use and

determining a wireless link used by a traffic from a stability of a band for each modulation method used for the wireless link and a traffic pattern for each priority of a path.

(Supplementary Note 9)

The communication device described in Supplementary note 8 characterized in that a traffic distribution is performed to the traffics on the same path so as to satisfy the communication quality required by each traffic according to the traffic pattern and the priority of the path.

(Supplementary Note 10)

The communication device described in Supplementary note 8 or Supplementary note 9 characterized in that the traffic pattern is a pattern indicating a characteristic of the traffic that includes at least one of an average traffic amount, a maximum traffic amount, and a burst characteristic.

(Supplementary Note 11)

The communication device described in any one of Supplementary notes 8 to 10 characterized in that the modulation method used for the wireless link is predicted and the stability of the band for the modulation method used for the wireless link is calculated based on the predicted modulation method.

(Supplementary Note 12)

The communication device described in any one of Supplementary notes 8 to 11 characterized in that the stability of the band for the modulation method used for the wireless link is calculated based on a history of the modulation method used for the wireless link and a history of information indicating a radio wave environment of the wireless link.

(Supplementary Note 13)

The communication device described in any one of Supplementary notes 8 to 12 characterized in that from a size of the band in which the stability of the wireless link is equal to or greater than a predetermined value set in advance and a traffic amount of each path,

the band of the wireless link in which the stability is equal to or greater than the predetermined value set in advance and which has a band equal to or greater than the traffic amount is allocated to at least a first traffic which has a higher priority of each path, and

a plurality of wireless links on a per-packet basis based on a ratio of an unused band from which the band used by the first traffic of each wireless link is excluded are allocated to at least a second traffic which has a lower priority of each path.

(Supplementary Note 14)

The communication device described in any one of Supplementary note 8 to 13 characterized in that from a size of the band in which the stability of the wireless link is equal to or greater than a predetermined value set in advance and a traffic amount of each path,

the band of the wireless link in which the stability is equal to or greater than the predetermined value set in advance and which has a band equal to or greater than the traffic amount is allocated to at least the first traffic which has a higher priority of each path, and

an average traffic amount of the second traffic of each path and the unused band in each wireless link are compared with each other and the wireless link is allocated to at least the second traffic which has a lower priority of each path based on the difference between the unused band and the average traffic amount.

(Supplementary Note 15)

A communication system characterized in that a plurality of wireless links between node devices are bundled for use and
the node device determines the wireless link used by a traffic from a stability of a band for each modulation method used for the wireless link
   and a traffic pattern for each priority of a path.

(Supplementary Note 16)

The communication system described in Supplementary note 15 characterized in that the node device performs a traffic distribution to the traffics on the same path so as to satisfy the communication quality required by each traffic according to the traffic pattern and the priority of the path.

(Supplementary Note 17)

The communication system described in Supplementary note 15 or Supplementary note 16 characterized in that the traffic pattern is a pattern indicating a characteristic of the traffic that includes at least one of an average traffic amount, a maximum traffic amount, and a burst characteristic.

(Supplementary Note 18)

The communication system described in any one of Supplementary notes 15 to 17 characterized in that the node device predicts the modulation method used for the wireless link and calculates the stability of the band for the modulation method used for the wireless link based on the predicted modulation method.

(Supplementary Note 19)

The communication system described in any one of Supplementary notes 15 to 18 characterized in that the node device calculates the stability of the band for the modulation method used for the wireless link based on a history of the modulation method used for the wireless link and a history of information indicating a radio wave environment of the wireless link.

(Supplementary Note 20)

The communication system described in any one of Supplementary notes 15 to 19 characterized in that from a size of the band in which the stability of the wireless link is equal to or greater than a predetermined value set in advance and a traffic amount of each path,

the node device allocates the band of the wireless link in which the stability is equal to or greater than the predetermined value set in advance and which has a band equal to or greater than the traffic amount to at least a first traffic which has a higher priority of each path and

allocates a plurality of wireless links on a per-packet basis to at least a second traffic which has a lower priority of each path based on a ratio of an unused band from which the band used by the first traffic of each wireless link is excluded.

(Supplementary Note 21)

The communication system described in any one of Supplementary notes 15 to 19 characterized in that from a size of the band in which the stability of the wireless link is equal to or greater than a predetermined value set in advance and a traffic amount of each path,

the node device allocates the band of the wireless link in which the stability is equal to or greater than the predetermined value set in advance and which has a band equal to or greater than the traffic amount to at least the first traffic which has a higher priority of each path and

compares an average traffic amount of the second traffic of each path with the unused band in each wireless link and allocates the wireless link to at least the second traffic which has a lower priority of each path based on the difference between the unused band and the average traffic amount.

Further, each disclosure of the above-mentioned patent literature and non-patent literature is hereby incorporated by reference in its entirety. Modification and adjustment of the exemplary embodiment can be made within the scope of the overall disclosure (including claims) of the present invention and based on the basic technical concept of the present invention. Moreover, various combinations or selections of the various disclosed elements (including each element of each supplementary note, each element of each exemplary embodiment, and each element or the like of each drawing) are possible within the scope of the claims of the present invention. Namely, various deformations or modifications that may be made by those skilled in the art according to the overall disclosure including the claims and the technical concept are included in the present invention.

The invention of the present application has been described above with reference to the exemplary embodiment. However, the invention of the present application is not limited to the above mentioned exemplary embodiment. Various changes in the configuration or details of the invention of the present application that can be understood by those skilled in the art can be made without departing from the scope of the invention of the present application.

This application claims priority based upon and claims the benefit of priority from Japanese Patent Application No. 2012-035844, filed on Feb. 22, 2012, the disclosure of which is incorporated herein in its entirety by reference.

### REFERENCE SIGNS LIST

101 and 102 communication device
111 and 112 wireless link
401 used link setting of each traffic in initial stage
402 used link setting of each traffic after resetting
501 frame processing unit
502 link information management unit
503 resource management unit
504 traffic information management unit
511, 512, 513, and 514 communication unit

1. A traffic control method comprising:
bundling a plurality of wireless links between nodes for use, and
determining the wireless link used by a traffic from a stability of a band for each modulation method used for each wireless link and a traffic pattern for each priority of a path.

2. The traffic control method described in claim 1 wherein that a traffic distribution is performed to the traffics on the same path so as to satisfy the communication quality required by each traffic according to the traffic pattern and the priority of the path.

3. The traffic control method described in claim 1 wherein the traffic pattern comprises a pattern indicating a characteristic of the traffic that includes at least one of an average traffic amount, a maximum traffic amount, and a burst characteristic.

4. The traffic control method described in claim 1 wherein the modulation method used for the wireless link is predicted and the stability of the band for the modulation method used for the wireless link is calculated based on the predicted modulation method.

5. The traffic control method described in claim 1 wherein the stability of the band for the modulation method used for the wireless link is calculated based on a history of the modulation method used for the wireless link and a history of information indicating a radio wave environment of the wireless link.

6. The traffic control method described in claim 1 wherein from a size of the band in which the stability of the wireless link is equal to or greater than a predetermined value set in advance and a traffic amount of each path,
the band of the wireless link in which the stability is equal to or greater than the predetermined value set in advance and which has a band equal to or greater than the traffic amount is allocated to at least a first traffic which has a higher priority of each path, and
a plurality of wireless links on a per-packet basis based on a ratio of an unused band from which the band used by the first traffic of each wireless link is excluded are allocated to at least a second traffic which has a lower priority of each path.

7. The traffic control method described in claim 1 wherein from a size of the band in which the stability of the wireless link is equal to or greater than a predetermined value set in advance and a traffic amount of each path,
the band of the wireless link in which the stability is equal to or greater than the predetermined value set in advance and which has a band equal to or greater than the traffic amount is allocated to at least the first traffic which has a higher priority of each path, and
an average traffic amount of the second traffic of each path and the unused band in each wireless link are compared with each other and the wireless link is allocated to at least the second traffic which has a lower priority of each path based on the difference between the unused band and the average traffic amount.

8. A communication device comprising a unit which
bundles a plurality of wireless links between the communication devices for use and
determines a wireless link used by a traffic from a stability of a band for each modulation method used for the wireless link and a traffic pattern for each priority of a path.

9. The communication device described in claim 8 wherein a traffic distribution is performed to the traffics on the same path so as to satisfy the communication quality required by each traffic according to the traffic pattern and the priority of the path.

10. The communication device described in claim 8 wherein the traffic pattern comprises a pattern indicating a characteristic of the traffic that includes at least one of an average traffic amount, a maximum traffic amount, and a burst characteristic.

11. The communication device described in claim 8 wherein the modulation method used for the wireless link is predicted and the stability of the band for the modulation method used for the wireless link is calculated based on the predicted modulation method.

12. The communication device described in claim 8 wherein the stability of the band for the modulation method used for the wireless link is calculated based on a history of the modulation method used for the wireless link and a history of information indicating a radio wave environment of the wireless link.

13. The communication device described in claim 8 wherein from a size of the band in which the stability of the wireless link is equal to or greater than a predetermined value set in advance and a traffic amount of each path,
the band of the wireless link in which the stability is equal to or greater than the predetermined value set in advance and which has a band equal to or greater than the traffic amount is allocated to at least a first traffic which has a higher priority of each path, and
a plurality of wireless links on a per-packet basis based on a ratio of an unused band from which the band used by the first traffic of each wireless link is excluded are allocated to at least a second traffic which has a lower priority of each path.

14. The communication device described in claim 8 wherein from a size of the band in which the stability of the wireless link is equal to or greater than a predetermined value set in advance and a traffic amount of each path,
the band of the wireless link in which the stability is equal to or greater than the predetermined value set in advance and which has a band equal to or greater than the traffic amount is allocated to at least the first traffic which has a higher priority of each path, and
an average traffic amount of the second traffic of each path and the unused band in each wireless link are compared with each other and the wireless link is allocated to at least the second traffic which has a lower priority of each path based on the difference between the unused band and the average traffic amount.

15. A communication system wherein a plurality of wireless links between node devices are bundled for use and
the node device determines the wireless link used by a traffic from a stability of a band for each modulation method used for the wireless link
and a traffic pattern for each priority of a path.

16. The communication system described in claim 15 wherein the node device performs a traffic distribution to the traffics on the same path so as to satisfy the communication quality required by each traffic according to the traffic pattern and the priority of the path.

17. The communication system described in claim 15 wherein the traffic pattern comprises a pattern indicating a characteristic of the traffic that includes at least one of an average traffic amount, a maximum traffic amount, and a burst characteristic.

18. The communication system described in claim 15 wherein the node device predicts the modulation method used for the wireless link and calculates the stability of the band for the modulation method used for the wireless link based on the predicted modulation method.

19. The communication system described in claim 15 wherein the node device calculates the stability of the band for the modulation method used for the wireless link based on a history of the modulation method used for the wireless link and a history of information indicating a radio wave environment of the wireless link.

20. The communication system described in claim 15 wherein from a size of the band in which the stability of the wireless link is equal to or greater than a predetermined value set in advance and a traffic amount of each path,
the node device allocates the band of the wireless link in which the stability is equal to or greater than the predetermined value set in advance and which has a band equal to or greater than the traffic amount to at least a first traffic which has a higher priority of each path and
allocates a plurality of wireless links on a per-packet basis to at least a second traffic which has a lower priority of each path based on a ratio of an unused band from which the band used by the first traffic of each wireless link is excluded.
